(19) United States
(12) Patent Application Publication
(10) Pub. No.: US 2001/0023270 A1
(43) Pub. Date: Sep. 20, 2001

(54) Phosphite stabilizing composition and method

(76) Inventors: Daryl L. Stein, North Canton, OH (US); Marc Nolen, Dover, OH (US)

Correspondence Address: OLDHAM & OLDHAM CO, TWIN OAKS ESTATE, 1225 W MARKET STREET, AKRON, OH, 44313, US

(21) Appl. No.: 09/833,776

(22) Filed: Apr. 12, 2001

Related U.S. Application Data
(63) Continuation of application No. 09/498,850, filed on Feb. 7, 2000.
(60) Provisional application No. 60/119,006, filed on Feb. 8, 1999.

(51) Int. Cl. C08K 5/04; C08K 5/51; C09K 3/00

(52) U.S. Cl. 524/128; 524/394; 252/389.24

(57) ABSTRACT

A stabilizer composition for polymers is provided comprising bis(2,4-dicumylphenyl) pentaerythritol diphosphite and at least one metal salt of the lactic acid, and optionally one or more additional phosphites and other antioxidants.

### TECHNICAL FIELD

The present invention is directed to a stabilizer composition for polymers comprising bis(2,4-dicumylphenyl) pentaerythritol diphosphite and at least one metal salt of a lactic acid.

### BACKGROUND OF THE INVENTION

The use of phosphites as polymer stabilizers is well known in the art. In particular, the use of pentaerythritol diphosphites having superior hydrolytic stability over other phosphites has been shown to be desirable. More specifically, bis(2,4-dicumylphenyl) pentaerythritol diphosphite exhibits excellent hydrolytic stability and comparable polymer stabilizing capability as compared to other pentaerythritol disphosphites. It is further known to add secondary antioxidants to enhance the stabilizing capability of phosphites in polymers. For example, calcium stearoyllactate in combination with bis(2,6-di-t-butyl-4-methylphenyl) pentaerythritol diphosphite has been shown to stabilize a polymer composition during extrusion of the composition. Other phosphites, such as bis(2,4-di-t-butyphenyl) pentaerythritol diphosphite have also been proposed for use with calcium stearoyllactate and other metal lactate salts.

The excellent hydrolytic stability of bis(2,4-dicumylphenyl) pentaerythritol diphosphite tnakes its use desirable. However, a need exists for a bis(2,4-dicumylphenyl) pentaerythritol diphosphite composition that exhibits superior polymer stabilizing capability.

### SUMMARY OF THE INVENTION

It has now been found that a composition comprising bis(2,4-dicumylphenyl) pentaerythritol diphosphite and a metal salt of a lactic acid gives unexpectedly superior performance as a polymer stabilizer as compared with prior art compositions comprising other phosphites. As one indicator of the unexpectedly superior performance, a composition comprising bis(2,4-dicumylphenyl) pentaerythritol diphosphite and a metal salt of a lactic acid when used as a polymer stabilizer show superior color after five extrusion passes than for a composition comprising bis(2,4-di-t-butylphenyl) pentaerythrito disphosphite.

It is, therefore, an object of the present invention to provide a composition capable of stabilizing polymers, comprising bis(2,4-dicumylphenyl) pentaerythritol disphosphite and at least one metal salt of a lactic acid.

It is a further object of the present invention to provide a method of stabilizing polymers, comprising adding to a polymer composition bis(2,4-dicumylphenyl) pentaerythritol disphosphite and at least one metal salt of a lactic acid.

### DETAILED DESCRIPTION OF THE INVENTION

It has now been found that a composition comprising bis(2,4-dicumylphenyl) pentaerythritol diphosphite and a metal salt of a lactic acid gives unexpectedly superior performance as a polymer stabilizer as compared with prior art compositions comprising other phosphites. As one indication of the unexpectedly superior performance, a composition comprising bis(2,4-dicumylphenyl) pentaerythritol diphosphite, shown in Formula I, and a metal salt of a lactic acid when used as a polymer stabilizer show superior color after five extrusion passes than for an analogous composition comprising bis(2,4.:.di-t-butylphenyl) pentaerythritol disphosphite, shown in Formula II.

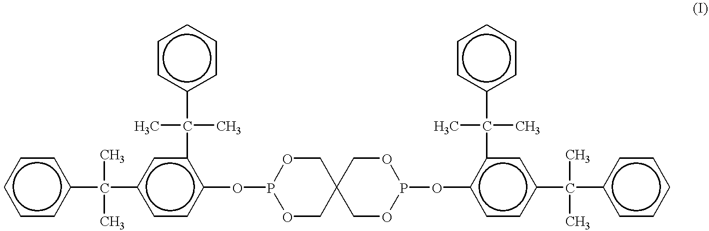

Bis(2,4-dicumylphenyl) pentaerythritol diphosphite is available commercially as Doverphos S-9228 from Dover Chemical Corporation and can be made as disclosed in U.S. Pat. No. 5,438,086. The present invention includes the use of mixtures or blends of bis (2,4-dicumylphenyl) pentaerythritol diphosphite and metal salts of lactic acid, such as calcium lactate, calcium stearoyl-2-lact;ylate or combinations of metal lactate salts as stabilizers for polymers. These blends may be used with other polymer additives.

One advantage of these blends is that the consumer only has to weigh, measure, or meter one blend instead of two or more of the individual components of the blend. Thus the chance of weighing errors is reduced. Moreover, it is easier to weigh and handle a larger amount of one material than it is smaller amounts of several materials. Finally, the blends of this invention provide better protection against polymer degradation than do the current commercially available blends.

Metal salts of lactic acids useful in the present invention include metal salts of blends of lactic acid with other organic acids such as fatty acids. Useful metal salts of lactic acid include calcium lactate and calcium stearoyl-2-lact;ylate. Suitable metals include alkaline earth metals such as calcium, barium, strontium and radium. Suitable metals also include alkali metals such as lithium, sodium, potassium, rubidium, cesium, francium, cadmium, lead, zinc, tin, magnesium and antimony. In one embodiment, the metal is bivalent so that the salt may be a co-salt of lactic acid and a fatty acid. Organic acids suitable for use in combination with the lactic acid include stearic acid, lauric acid, palmitic acid, butyric acid ˜d other C4 to C22 fatty acids, including both saturated and unsaturated fatty acids, including linoleic and linolenic acids.

In one embodiment, the salt is a, bivalent metal co-salt of lactic acid and a fatty 5 acid, which may be a saturated fatty acid. In this embodiment, the bivalent metal is calcium, the saturated fatty acid is stearic acid, and the metal co-salt is calcium stearoyl-2-lactylate. Suitable other co-salts of lactic acid include calcium lauroyllactate, calciun palmitoyllactate and calcium butroyllactate.

Examples of these metal lactate salts useful in the present invention are sold under trade names Pationic 930, Pationic 940, Pationic 1230, Pationic 1240, and Pationic 1250 by the American Ingredients Company. The weight ratio of phosphite to metal lactate salt may be any ratio between 1:1 and 100:1. One or more of the metal lactate salts useful in the present invention may be used simultaneously in a stabilizer combination with bis(2,4-dicumylphenyl) pentaerythritol diphosphite.

The primary phosphite used in this invention is bis(2,4-dicumylphenyl) pentaerythritol diphosphite. However, other phosphites, if desired, may be used in a mixture with it. These other phosphites that may be used are selected from a group consisting of tris(2,4-di-t-butylphenyl) phosphite (Doverphos $-480), distearyl pentaerythritol diphosphite (Doverphos $-680), trisnonylphenylphosphite (Doverphos 4), 20 phenyl diisodecyl phosphite (Doverphos 7), diphenyl isodecyl phosphite (Doverphos 8), triphenyl phosphite (Doverphos 10), trilauryl phosphite (Doverphos 53), alkyl (CI2-CI5) bisphenol A phosphite (Doverphos 613), alkyl (C1O) bisphenol A phosphite (Doverphos 675), bis(2,4-di-t-butylphenyl) pentaerythritol diphosphite (Ultranox 626), 2-butyl-2-ethyl-1,3-propanediol2,4,6-tri-t-butylphenol phosphite (Ultranox 641), bis(2,6-di-t-butyl-4-methylphenyl) pentaerythritol diphosphite (PEP 36), tetrakis(2,4-di-t-butylphenyl) 4,4′-diphenylenediphosphphonite (P-EPQ), 2,2′-ethylidene bis(4,6-di:.t-butylphenyl)fluorophosphonite (Ethanox 398), bis(2,4-di-t-butyl-6-methylphenyl) ethyl phosphite (Irgafos 38) and 2,2′,2″-nitrilotriethanol tris[3,3′,5,5′-tetra-tert-butyl-1,11-biphenyl-2,2′-diyl)-phosphite (Irgafos 12).

Useful additional phosphites that may be used in conjunction with bis(2,4-dicumylphenyl) pentaerythritol diphosphite are tris(2,4-di-t-butylphenyl) phosphite, bis-(2,4.di-t-butylphenyl) pentaerythritol diphosphite and tetrakis(2,4-di-t-butylphenyl) 4,41-diphenylenediphosphonite.

Additional phosphites may be used with bis(2,4-dicumylphenyl)pentaerythritol diphosphite in any weight ratio from about 10:1 to about 1:10. One or more additional phosphites may be used simultaneously in a composition with bis(2,4-dicumylphenyl) pentaerythritol diphosphite.

These blends maybe prepared by methods known in the art such as by dry blending, melt mixing, grinding, and ball milling.

Furthermore, the stabilizer blends of this invention may be used with other polymer additives such as hindered phenol antioxidants. Examples of hindered phenol antioxidants that may be used with bis(2,4-dicumylphenyl)pentaerythritol diphosphite/calcium lactate or calcium stearoyl-2-lactylate salts are selected from a group consisting of 2,6-di-t-butyl-4-methylphenol (BHT), 2,6-di-t-butyl-4-ethylphenol, tetrakis(methylene (3,5-di -t-butyl-4-hydroxyhydrocinnamate)]methane (Dovemox 10), 15 octadecyl3,5-di-t-butyl-4-hydroxyhydrocinnamate (Dovemox 76), tris(3,5-di-t-butyl-4-hydroxybenzyl)-1,3,5-triazine-2,4,6(1H, 3H, 5H)-trione (Dovemox 3114), and α-tocopherol (Vitamin E). Other examples of hindered phenol antioxidants are given in U.S. Pat. No. 5,364,895 and are hereby incorporated by reference. One or more hindered phenols may be used simultaneously in a composition with bis(2 ,4-dicumylphenyl) pentaerythritol diphosphite.

In addition to hindered phenols, the blends of bis(2,4-dicumylphenyl) pentaerythritol diphosphite and hindered phenols may be used with other polymer stabilizers such as UV absorbers and light stabilizers, metal deactivators, peroxide scavengers, basic co-stabilizers, nucleating agents, fillers and reinforcing agents, aminoxy propanoate derivatives, plasticizers, lubricants, emulsifiers, pigments and dyes, optical brighteners, flame-proofing agents, antistatic agents, blowing agents, cross-linking agents, antiblocking agents, slip agents, processing aids, and thiosynergists. Specific examples of these other polymer additives are disclosed in U.S. Pat. No. 5,438,086 and are hereby incorporated by reference.

The polymers in which the blends may be used are polyolefins such as polyethylene and polypropylene, PET, PBT, polystyrene, polyacrylics, polycarbonates, PVC, EPDM, SAN, PPO, SBR, ABS, and nylons. The stabilizer combination of bis(2,4-dicumylphenyl) pentaerythritol disphosphite, metal lactate salts, any additional phosphites, and any hindered phenols may be used in a combined amount from about 10 ppm to about 10,000 ppm in a polymer composition. The stabilizer blends may be compounded into the polymers by methods known in the art.

The present invention is further illustrated by the following examples.

### EXAMPLES

### Example I

A dry blend of 9 parts bis(2,4-dicumylphenyl)pentaerythritol diphosphite and I part Pationic 940 (overbased calcium stearoyl-2-lactylate) was prepared and was labeled Blend I. A second dry blend of9 parts bis(2,4-dicumylphenyl)pentaerythritol diphosphite and 1 part Pationic 1240 (overbased calcium lactate) was prepared and was labeled Blend 2. These blends were added to high density polyethylene powder along with the antioxidant Dovemox 10 (tetrakis[methylene (3,5-di-t-butyl-4-hydroxyhydrocinnamate)]methane) and the acid neutralizer zinc stearate. The polyethylene powder was then subjected to multiple pass extrusion at 230° C. and 60 rpm using a Brabender Model PL 2000 single screw laboratory extruder. The extruded resin was then tested for changes in melt flow and color. The results along with those for three comparative examples C, D, and E are given in Table I.

TABLE 1

| | A | B | C | D | E |
|---|---|---|---|---|---|
| Material (ppm)/ | | | | | |
| Formulation | | | | | |
| Doverphos 10¹ | 500 | 500 | 500 | 500 | 500 |
| Zinc Stearate | — | 500 | 500 | 500 | 500 |
| Pationic 940² | 100 | — | — | — | — |
| Pationic 1240³ | — | 100 | — | — | — |
| Doverphos S9228⁴ | 900 | 900 | 1000 | — | — |
| Ultranox 626⁵ | — | — | — | 1000 | — |
| Melt Flow (g/10 min) | | | | | |
| 1-Pass | 9.6 | 9.1 | 9.0 | 10.2 | 6.9 |
| 3-Pass | 11.2 | 11.0 | 10.9 | 10.8 | 7.4 |
| 5-Pass | 12.0 | 10.6 | 10.6 | 10.3 | 9.6 |
| Color (Yellowness | | | | | |
| Index) | | | | | |
| 1-Pass | −6.4 | −4.9 | −5.5 | −5.1 | −1.8 |
| 3-Pass | −3.5 | −3.4 | −1.8 | −2.5 | −0.6 |
| 5-Pass | −1.1 | −0.3 | 0.2 | 0.2 | 3.8 |

¹tetrakis[methylene (3,5-di-t-butyl-4-hydroxyhydrocinnamate)]methane
²overbased calcium stearoyl-2-lactylate
³overbased calcium lactate
⁴bis(2,4-dicumylphenyl) pentaerythritol diphosphite, formula (I)
⁵bis(2,4-di-t-butylphenyl) pentaerythritol disphosphite, formula (II)

Lower melt flow and lower yellowness index values are desirable and indicate better stability during processing. The results show that while all the formulations provide good melt flow stability only the formulations A and B using the blends of this invention provide low yellowness index values.

### Example 2

A dry blend of 500 parts Doverphos S9228T (bis(2,4-dicumylphenyl) pentaerythritoldiphosphite) and 300 parts Pationic 1240 (overbased calcium lactate) was

TABLE 1

| | A | B | C | D | E |
|---|---|---|---|---|---|
| Material (ppm)/ | | | | | |
| Formulation | | | | | |
| Doverphos 10¹ | 500 | 500 | 500 | 500 | 500 |
| Zinc Stearate | — | 500 | 500 | 500 | 500 |
| Pationic 940² | 100 | — | — | — | — |
| Pationic 1240³ | — | 100 | — | — | — |
| Doverphos S9228⁴ | 900 | 900 | 1000 | — | — |
| Ultranox 626⁵ | — | — | — | 1000 | — |
| Melt Flow (g/10 min) | | | | | |
| 1-Pass | 9.6 | 9.1 | 9.0 | 10.2 | 6.9 |
| 3-Pass | 11.2 | 11.0 | 10.9 | 10.8 | 7.4 |
| 5-Pass | 12.0 | 10.6 | 10.6 | 10.3 | 9.6 |
| Color (Yellowness | | | | | |
| Index) | | | | | |
| 1-Pass | −6.4 | −4.9 | −5.5 | −5.1 | −1.8 |
| 3-Pass | −3.5 | −3.4 | −1.8 | −2.5 | −0.6 |
| 5-Pass | −1.1 | −0.3 | 0.2 | 0.2 | 3.8 |

¹tetrakis[methylene (3,5-di-t-butyl-4-hydroxyhydrocinnamate)]methane
²overbased calcium stearoyl-2-lactylate
³overbased calcium lactate
⁴bis(2,4-dicumylphenyl) pentaerythritol diphosphite, formula (I)
⁵bis(2,4-di-t-butylphenyl) pentaerythritol disphosphite, formula (II)

Lower melt flow and lower yellowness index values are desirable and indicate better stability during processing. The results show that while all the formulations provide good melt flow stability only the formulations A and B using the blends of this invention provide low yellowness index values.

### Example 2

A dry blend of 500 parts Doverphos S9228T (bis(2,4-dicumylphenyl) pentaerythritoldiphosphite) and 300 parts Pationic 1240 (overbased calcium lactate) was prepared and was labeled Blend F. A second dry blend of 500 parts Ultranox 626 (bis(2,4-di-t-butylphenyl) pentaerythritol diphosphite) and 300 parts Pationic 1240 was prepared and was labeled Blend G. A third dry blend of 667 parts DoverphosS9228T (bis(2,4-dicurnylphenyl) pentaerythritol diphosphite) and 300 parts Pationic 1240 ( overbased calcium lactate) was prepared and was labeled Blend H. A fourth dry blend of 667 parts Ultranox 626 (bis(2,4-di-t-butylphenyl) pentaerytllritol diphosphite) and 300 parts Pationic 1240 was prepared and was labeled Blend I. These blends were added to high density Profax 6501 polyethylene (Montell) powder along with the antioxidant Dovemox 10 tetrakis[methylene (3,5-di-t-butyl-4-hydroxyhydrocinnamate)]methane) and the acid neutralizer zinc stearate. The polyethylene powder was then subjected to multiple pass extrusion at 260° C. and 60 rpm using a Brabender Model PL 2000 single screw laboratory extruder. The extruded resin was then tested for changes in melt flow and color. The results are given in Table 2.

Lower melt flow and lower yellowness index values are desirable and indicate better stability during processing. The results show that while all the formulations F, G, H, and I provide comparably good melt flow stability, the formulations F and H using the blends with bis(2,4-dicumylphenyl) pentaerythritol diphosphite and a metal lactate salt provide significantly lower 5-pass yellowness index values as compared with blends G and I using bis(2,4-di-t-butylphenyl) pentaerythritol diphosphite and a metal lactate salt. 20 This result is suprisingly unexpected.

The invention has been described with reference to several embodiments. Obviously, modifications and alterations will occur to others upon the reading and understanding of the specification. It is intended to include all such modifications and alterations insofar as they come within the scope of the appended claims or the equivalents thereof.

TABLE 2

| | F | G | H | I |
|---|---|---|---|---|
| Material (ppm)/Formulation | | | | |
| Dovernox 10¹ | 500 | 500 | 333 | 333 |
| Zinc Stearate | — | — | — | — |
| Pationic 940² | — | — | — | — |
| Pationic 1240³ | 300 | 300 | 300 | 300 |
| Doverphos S9228⁴ | 500 | — | 667 | — |
| Ultranox 626⁵ | — | 500 | — | 667 |
| Melt Flow (g/10 min) | | | | |
| 1-Pass | 3.9 | 3.4 | 3.9 | 3.7 |
| 3-Pass | 4.3 | 4.0 | 4.5 | 4.2 |
| 5-Pass | 5.2 | 5.2 | 5.2 | 5.2 |
| Color (Yellowness Index) | | | | |
| 1-Pass | 3.5 | 3.2 | 3.4 | 2.5 |
| 3-Pass | 4.4 | 4.8 | 3.9 | 3.8 |
| 5-Pass | 5.5 | 6.0 | 4.6 | 5.1 |

¹tetrakis[methylene (3,5-di-t-butyl-4-hydroxyhydrocinnamate)]methane
²overbased calcium-2-lactylate
³overbased calcium lactate
⁴bis(2,4-dicumylphenyl) pentaerythritol diphosphite, formula (I)
⁵bis(2,4-di-t-butylphenyl) pentaerythritol disphosphite, formula (II)

What is claimed is:

1. A composition capable of stabilizing polymers, comprising: bis(2,4-dicumylphenyl) pentaerythritol disphosphite; and at least one metal salt of a lactic acid.

2. The composition of claim 1, further comprising at least one additional phosphite.

3. The composition of claim 1, further comprising at least one additional phosphite selected from the group consisting of tris(2,4-di-t-butylphenyl) phosphite, distearyl pentaerythritol diphosphite, trisnonylphenyl phosphite, phenyl diisodecyl phosphite, diphenyl isodecyl phosphite, triphenyl phosphite, trilauryl phosphite, alkyl(C12-C1S) bisphenol A phosphite, alkyl (CIO) bisphenol A phosphite, bis(2,4-di-t-butylphenyl) pentaerythritol diphosphite, 2-butyl-2-ethyl-1,3-propanediol2,4,6-tri-t-butylphenol phosphite, bis(2,6-di-t-butyl-4-methylphenyl) pentaerythritol diphosphite, tetrakis(2,4-di-t-butylphenyl) 4,41-diphenylenediphosphphonite, 2,2′-ethylidene bis( 4,6-di-t-butylphenyl)fluorophosphonite, bis(2,4-di-t-butyl-6-methylphenyl) ethyl phosphite, and 15 2,2′,2″-nitrilotriethanol tris(3,3′,5,5′-tetra-tert-butyl-1,1′-biphenyl-2,2′-diyl)-phosptite.

4. The composition of claim 1, wherein said at least one metal salt of a lactic acid is selected from the group consisting of calcium lactate and calcium stearoyl-2-lactylate.

5. The composition of claim 1, wherein said at least one metal salt of a lactic acid is a co-salt of lactic acid and a fatty acid.

6. The composition of claim 1, wherein said bis(2,4-dicumylphenyl) pentaerythritol disphosphite and said at least one metal salt of a lactic acid are present in a weight ratio of from about 1:1 to about 100:1.

7. The composition of claim 2, wherein said bis(2,4-dicumylphenyl) pentaerythritol disphosphite and said at least one additional phosphite are present in a weight ratio of from about 10:1 to about 1:10.

8. The composition of claim 1, further comprising at least one hindered phenol alltioxidant.

9. The composition of claim 1, further comprising at least one hindered phenol antioxidant selected from the group consisting of2,6-di-t-butyl-4-methylphenol, 2,6-di-t-butyl-4-ethylphenol, tetrakis( methylene (3,5-di-t-butyl-4-hydroxyhydrocinnamate)]methane, octadecyl 3,5-di-t-butyl-4-hydroxyhydrocinnamate, 11 tris(3,5-di-t-butyl-4-hydroxybenzyl)-1,3,5-triazine-2,4,6(1H, 3H, 5H)-trione, and a.-tocopherol.

10. A method of stabilizing a polymer composition comprising a polymer, said method comprising:
adding his(2,4-dicumylphenyl) pentaerythritol disphosphite and at least one metal salt of a lactic aci4 to said polymer composition.

11. The method of claim 10, wherein said polymer is selected from the group consisting of polyolefins, PET, PET, polystyrene, polyacrylics, polycarbonates, PVC, EPDM, SAN, PPO, SER, ADS, and nylons.

12. The method of claim 10, further comprising adding at least one additional phosphite.

13. The method of claim 10, further comprising adding at least one additional phosphite selected from the group consisting of tris(2,4-di-t-butylphenyl) phosphite, distearyl pentaerythritol diphosphite, trisnonylphenyl phosphite, phenyl diisodecyl phosphite, diphenyl isodecyl phosphite, triphenyl phosphite, trilauryl phosphite, alkyl (CI2-CI5) bisphenolA phosp:hite, alkyl (C1O) bisphenol A phosphite, bis(2,4-di-t-butylphenyl) pentaerythritol diphosphite, 2-butyl-2-ethyl-1 ,3-propanediol 2,4,6-tri-t-butylphenol phosphite, his(2,6-di-t-butyl-4-methylphenyl) pentaerythritol diphosphite, tetrakis(2,4-di-t-butylphenyl) 4,4′-diphenylenediphosphphonite, 2,2′-ethylidene his( 4,6-di-t-butylphenyl)fluorophosphonite, bis(2,4-di-t-butyl-6-methylphenyl) ethyl phosphite, and 2,2′,2″-nitrilotriethanol tris[3,3′,5,5′-tetra-tert-butyl-1,1′-biphenyl-2,2′-diyl)-phosphite.

14. The method of claim 10, wherein said at least one metal salt of a lactic acid is selected from the group consisting of calcium lactate and calcium stearoyl-2-lactylate.

15. The method of claim 10, wherein said bis(2,4-dicumylphenyl) pentaerythritol disphosphite a11d said at least one metal salt of a lactic acid are present in a weight ratio of from about 1:1 to about 100:1.

16. The method of claim 12, wherein said bis(2,4-dicumylphenyl) pentaerythritol disphosphite and said at least one additional phosphite are present in a weight ratio of from about 10:1 to about 1:10.

17. The method of claim 10, further comprising adding at least one hindered phenol antioxidant.

18. The method of claim 10, further comprising adding at least one hindered phenol antioxidant selected from the group consisting of2,6-di-t-butyl-4-metllylphenol, 2,6-di-t-butyl-4-ethylphenol, tetrakis[methylene (3,S-di-t-butyl-4-hydroxyhydrocinnamate)]methane, octadecyl 3,S-di-t-butyl-4-hydroxyhydiocinnamate, S tris(3,5-di-t-butyl-4-hydroxybenzyl)-1,3,S-triazine-2,4,6(1H, 3H, SH)-trione, and a.-tocopherol.

19. The method of claim 10, wherein said bis(2,4-dicumylphenyl) pentaerythritol disphosphite and at least one metal salt of a lactic acid are added to said polymer composition in a combined amount ranging from about 10 ppm to about 10,000 ppm, based on the weight of the polymer composition.

20. The method of claim 12, wherein said bis(2,4-dicumylphenyl) pentaerythritol disphosphite, said at least one metal salt of a lactic acid, and said at least one additional phosphite are added to said polymer composition in a combined amount ranging from about 10 ppm to about 10,000 ppm, based on the weight of the polymer composition.
